(19) United States
(12) Patent Application Publication
(10) Pub. No.: US 2006/0005343 A1
(43) Pub. Date: Jan. 12, 2006

(54) Paint flow control apparatus for use inside paint cans, buckets, and the like

(76) Inventor: Kenneth W. Clingerman, Baltimore, MD (US)

Correspondence Address: Law Offices of Royal W. Craig, Suite 153, 10 N. Calvert Street, Baltimore, MD, 21202, US

(21) Appl. No.: 11/175,743

(22) Filed: Jul. 6, 2005

Related U.S. Application Data
(60) Provisional application No. 60/586,436, filed on Jul. 8, 2004.

(51) Int. Cl. B05C 21/00

(52) U.S. Cl. 15/257.06; 15/257.05

(57) ABSTRACT

A paint flow control apparatus for insertion into paint cans, buckets, and other storage containers for regulating the application of paint to rollers and brushes dipped therein. The apparatus generally includes a porous grid member, a perimeter member fixedly attached to the grid member, a filter screen detachably attached to the grid member, and two handles fixedly attached to the perimeter member. The perimeter member maintains the porous grid member slightly submerged beneath the surface of the paint so as to prevent drying and flaking of the paint, and the perimeter member abuts/interacts with the walls of the storage container to maintain the position of the grid member. The filter screen strains the paint, and the handles allow convenient extraction/removal of the apparatus. A paint roller can be rolled across the top of the grid member to pick up an appropriate amount of paint.

### CROSS-REFERENCE TO RELATED APPLICATION(S)

The present application derives priority from U.S. provisional patent application 60/586,436 filed Jul. 6, 2004.

### BACKGROUND OF THE INVENTION

1. Field of the Invention

The present invention relates to painting accessories and, more particularly, to a flow control apparatus for use in paint cans, buckets, and other paint storage containers that floats on the paint in a position that is substantially parallel to the surface, just below the surface, in order to control the flow of paint onto a roller or brush applicator.

2. Description of the Background

Those who painting by roller or brush applicator often immerse their applicator directly in the cylindrical paint can. It is well known to provide a tray or grid for use within cans, buckets, and other storage containers that allows rolling or wiping off excess paint, thereby controlling the amount of paint adhering to conventional roller and brush applicators. These trays are inevitably attached to the lip of the paint can and are suspended either inside or outside the can.

Variations on the foregoing theme are disclosed in U.S. Pat. No. 6,119,303 to Passafiume, U.S. Pat. No. 5,283,928 to Linn et al., U.S. Pat. No. 4,865,282 to Yonkman et al., U.S. Pat. No. 4,756,046 to Surface et al., U.S. Pat. No. 4,083,466 to McManaway, U.S. Pat. No. 3,394,425 to Welt, U.S. Pat. No. 2,893,030 to Avema, and U.S. Pat. No. 2,723,410 to Sprung et al.

More specifically, U.S. Pat. No. 6,119,303 to Passafiume discloses a paint draining grid for use with a conventional paint roller that is inserted in a container of paint. The paint draining grid includes a frame with hooked end portions for releasably attaching the grid to an upper rim of the container such that the grid extends into an interior region of the container. A grid member is attached to the frame and includes a plurality of openings for permitting the drainage of paint.

U.S. Pat. No. 5,283,928 to Linn et al. discloses a universal paint grid for attachment to either an internal or external ledge of a container. The grid comprises a member having a porous plate for rolling a paint roller thereon to remove excess paint from the roller, a pair of flexible lips/ears located on the member for engaging an internal/external ledge of a container to hold the paint grid therein.

U.S. Pat. No. 4,865,282 to Yonkman et al. discloses a combination paint roller wiper and paintbrush holder comprising a wiping surface with a plurality of hooks to hang the wiping surface in a paint bucket. The wiping surface is connected to a projection that engages the wall of the bucket when a paint roller is wiped on the wiping surface.

U.S. Pat. No. 4,756,046 to Surface et al. discloses a disposable stiff, plastic concave liner having a circular floor and a frusto-conical wall for a commercially available, reusable paint bucket of standardized configuration. The liner has a transverse floor rib and a pair of parallel wall ribs inclined relative to the floor. A paint rolling screen may be inserted into the liner and held immobile by the floor and wall ribs. The screen provides a means for rolling excess paint from a paint roller and the liner greatly reduces cleanup time following painting.

U.S. Pat. No. 4,083,466 to McManaway discloses a paint container extension that may be fixed to the top of a paint container for supporting a paint roller distributor or a wiping and saturating device to properly distribute paint on a roller surface. The paint distributor is formed having substantially parallel sides with hooks at the top for hanging on the top of the paint container extension. The distributor is hooked over the extension where the center of the distributor is closest to the lowest point around the top of the extension.

U.S. Pat. No. 3,394,425 to Welt discloses a paint distributor for use with paint rollers or the like comprising a perforated sheet preferably of expanded metal. Also included are hooks that extend beyond the ends of the sheet whereby the distributor can be adjustably positioned to accommodate the sheet within various sized cans and/or a paint tray.

U.S. Pat. No. 2,893,030 to Avema discloses a compact, economical one-piece paint roller wiping and saturating device which may be easily and readily inserted into and mounted on a paint bucket.

U.S. Pat. No. 2,723,410 to Sprung et al. discloses a paint feeding device for use with rollers which can be adapted for use in a container in which the paint or coating material is initially furnished.

All of the foregoing prior art references are designed to control the flow of paint onto conventional roller and brush applicators. All generally comprise ribbed or porous, substantially planar members supported at the paint container's rim and extending downward into the container in a position that is substantially perpendicular to the surface of the paint. After immersing a conventional roller in the paint, but before using it to apply the paint to a surface, the roller is rolled along the planar member to remove any excess paint. Then, due to the substantially vertical orientation of the planar member (i.e. perpendicular to the surface of the paint), most of the excess paint flows or drips back into the supply of paint held within the container. There are a number of drawbacks to this conventional approach.

First of all, paint containers (particularly gallon containers) have different shapes which preclude the paint grids from being used within all such containers. Plastic containers typically have an external ledge, while metal containers usually have an internal ledge. Since the paint grid must be held in the paint container, a paint grid which is usable with a container having an internal ledge is not generally usable with a container having an external ledge.

Additionally, the suspended planar members remain partially exposed to the atmosphere during use, or between cycles of use (i.e. the application of multiple coats of paint to the same surface). Thus, a portion of the excess paint typically dries somewhere on the planar member between strokes. The dried paint gives rise to two issues, (1) waste in the form of the paint that dried on the planar member instead of being applied to a surface, and (2) a source of particulate matter that may find its way back into the paint supply, be picked up by the roller, and applied to the surface being painted (resulting in an undesirable, uneven finish).

Not one of the above-described prior art devices, even those containing a grid-like structure (i.e. Passafiume, Linn et al., Yonkman et al., Surface et al., McManaway, Welt, and Sprung et al.), is intended for straining any particulate matter present in the paint due to, for example, the aforementioned drying process, or faulty manufacturing or packaging procedures/equipment. Therefore, each of the references and all other known prior art falls short of the optimum configuration for a paint flow control apparatus and, to the best of the knowledge of the present inventor, do not solve all the problems outlined above.

Consequently, there remains a need for an improved paint flow control apparatus that (1) eliminates the atmospheric exposure resulting in wasted paint and/or the formation of inappropriate particulate matter, (2) serves as a paint strainer to prevent any particulate matter from transferring onto the roller and subsequently being applied to a surface, (3) possesses a simple, yet scalable, design fabricated of buoyant, resilient, durable materials, and (4) may be economically manufactured and sold to provide for widespread use.

### SUMMARY OF THE INVENTION

It is, therefore, a primary object of the present invention to provide an improved paint flow control apparatus to allow a user to regulate the amount of paint applied to a conventional roller or brush applicator.

It is another object to provide an improved paint flow control apparatus as described above that has no atmospheric exposure and consequently does not result in wasted paint and/or the formation of inappropriate particulate matter.

Still another object of the present invention is to provide an improved paint flow control apparatus formed of materials providing an appropriate degree of buoyancy and durability, in order to float just below the surface of the paint, thereby facilitating the rolling of a paint roller across its top surface to pick up an appropriate amount of paint.

Another object of the present invention is to provide an improved paint flow control apparatus as described above having a perimeter that interacts with the walls of a conventional paint can, bucket, or other storage container to assist in maintaining the apparatus' position relative to the surface of the paint.

A further object of the present invention is to provide an improved paint flow control apparatus that serves as a strainer to prevent inappropriate particulate matter from transferring onto the roller and subsequently being applied to a surface.

Another object of the present invention is to provide an improved paint flow control apparatus that is simple and employs a circular scalable design for economical manufacturing, and which can be most easily inserted and extracted from a paint can/bucket/storage container.

These and other objects are accomplished by a paint flow control apparatus that is fabricated of appropriately buoyant materials, intended for use inside paint cans, buckets, and other storage containers, and generally circular in shape. The apparatus generally comprises a porous grid member, a perimeter member fixedly attached to the grid member, a screen member removably attached to the grid member, and two handles fixedly attached to the perimeter member. The grid member is defined by a plurality of through holes. The perimeter member of the present invention is intended to interact with the walls of the can[bucket/storage container to assist in maintaining the apparatus' position relative to the surface of the paint. The material of construction for the perimeter member is selected to provide an appropriate coefficient of friction with the walls of the storage container. The handles provide the means for extracting the apparatus from a paint can/bucket/storage container and may be formed with notches that allow the present invention to be temporarily supported by the top rim of the storage container while the storage container is being refilled. It is noteworthy that the present invention only needs to be extracted from the supply of paint, and the storage container, during the refilling process.

In use, the apparatus is designed to essentially float just below the surface of the paint and allow a paint roller to be rolled across its top surface to pick up an appropriate amount of paint. By floating just below the surface of the paint, the present invention eliminates the atmospheric exposure (i.e. the drying process) that results in wasted paint and/or the formation of inappropriate particulate matter. Paint is forced through the grid and screen members as downward force is applied by a roller being rolled back and forth across it. The screen member strains the paint prior to its pick up by the roller, thereby preventing the transfer of inappropriate particulate matter onto the roller and subsequently onto a wall, ceiling, etc.

The present invention is fabricated of materials chosen to provide the appropriate degree of buoyancy, resiliency, and durability required by the nature of its use. The present invention possesses a simple, yet scalable, design that may be economically manufactured and sold to provide for widespread use. Certain elements of the present invention may be manufactured using an injection molding process. While the great majority of paint storage containers are cylindrical in shape, requiring the present invention to assume the aforementioned circular configuration, the grid and screen members of the flow control apparatus may be formed as squares, rectangles, etc. to function within non-cylindrical storage containers.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a top view of a paint flow control apparatus 10 according to a preferred embodiment of the present invention.

FIG. 2 is a side perspective view of the paint flow control apparatus 10 of FIG. 1. FIG. 3 is a cross-sectional view taken along line A-A of FIG. 1 of the paint flow control apparatus 10 of FIGS. 1 and 2, shown positioned inside a storage container 80 within the supply of paint held therein.

FIG. 4 is a bottom view of the paint flow control apparatus 10 of FIGS. 1-3.

FIG. 5 is a top view of a paint flow control apparatus 50 according to an alternative embodiment of the present invention.

### DETAILED DESCRIPTION OF THE PREFERRED EMBODIMENTS

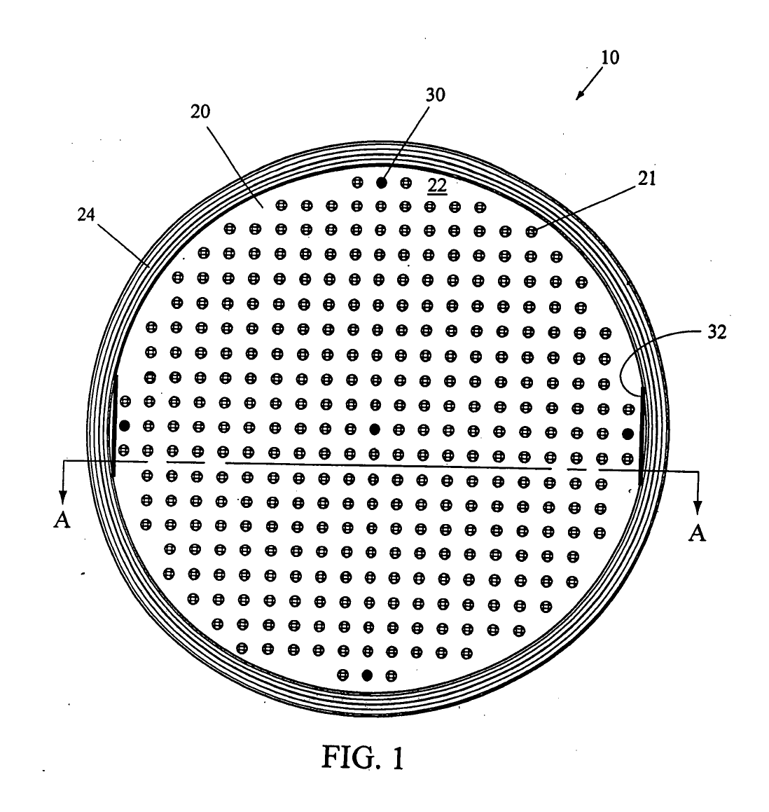

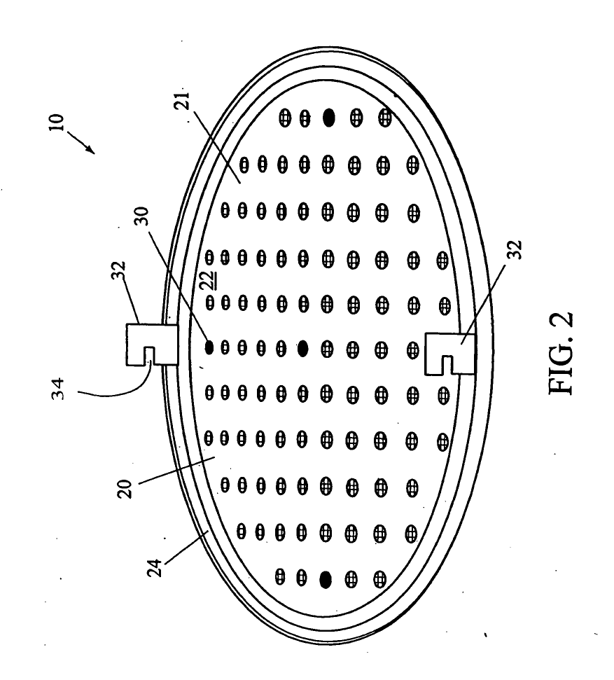

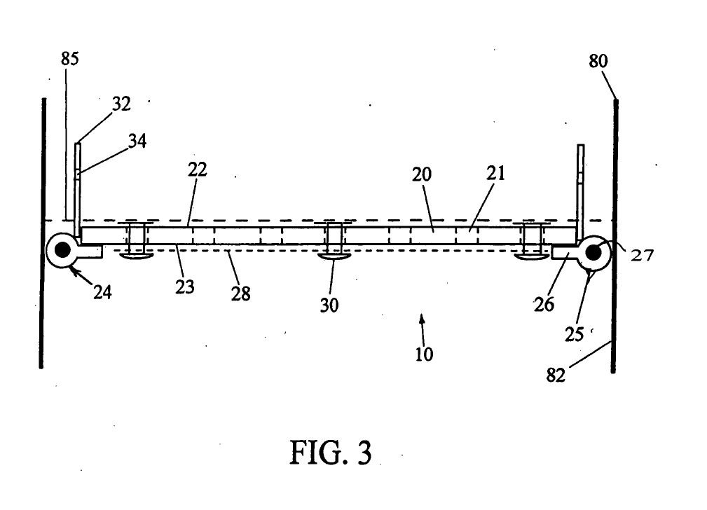

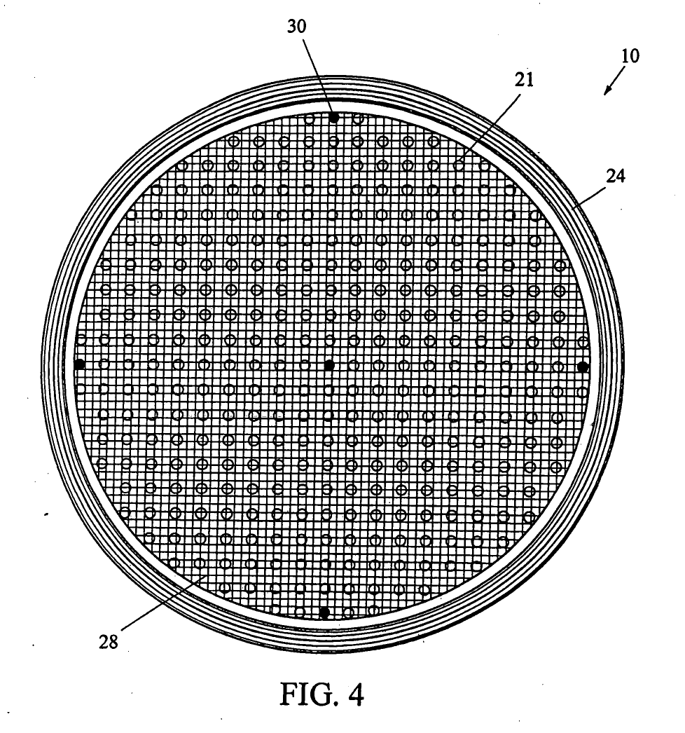

FIGS. 1-4 are, respectively, top, side perspective, cross-sectional, and bottom views of a paint flow control apparatus 10 according to a preferred embodiment of the present invention.

The apparatus 10 generally comprises a substantially circular and planar grid member 20, a buoyant perimeter member 24 peripherally encircling the grid member 20, a filter screen 28 underlying the grid member 20, and opposing handles 32 attached to perimeter member 24. One skilled in the art will understand that the circular format of FIGS. 1-4 is presently preferred for the vast majority of circular paint cans and buckets, but the flow control apparatus 10 may be adapted to take on other geometric shapes for non-circular paint cans and buckets, such as a square or a rectangle, without departing from the scope or spirit of the present invention. In such case the functionality remains the same.

The illustrated grid member 20 comprises a thin panel with a top surface 22, a bottom surface 23, and defined by a plurality of evenly-spaced through holes 21 through both top and bottom surfaces 22, 23. In the preferred embodiment (adapted for conventional paint buckets) the grid member 20 is circular with a 9″ diameter. However, the peripheral shape and size of the grid member 20 and overall flow control apparatus 10 may be varied as desired to conform to any paint bucket, including square, oblong, rectangular, etc. The through-holes 21 may be circular, square or any other suitable shape as a matter of design choice. The spacing between any two through holes 21 is preferably ⅜″, but may vary within a range of from 1/16″ to 5″. The aperture of all of the through holes 21 is uniform, such as 3/16″ diameter circles, and variable within a range of from 1/16″ and 3″. The grid member 20 is preferably formed from a commercially-available plastic material such as Acrylic™ or polyvinyl chloride (PVC). However, any material having appropriate resiliency and durability may be used. The grid member 20 is designed to submerge just below the surface of the paint, and preferably possesses a slightly lesser degree of buoyancy relative to conventional paint suspensions. In this regard the grid member 20 (or the material from which it is fabricated) may be weighted to achieve this end. The grid member 20 of the present invention may be manufactured using an injection molding process or may be cut from sheet form. As stated above, the grid member 20 of the present invention may, when desired, take on another geometric shape such as a square or a rectangle as desired to conform to odd-shaped paint storage containers.

The perimeter member 24 is fixedly attached about the circumference of the grid member 20 and is designed to interact with the internal surface 82 (see FIG. 3) of a conventional paint storage container 80 to maintain the apparatus 10 in the proper planar position relative to the surface 85 of the paint. As best seen in FIG. 3, the perimeter member 24 generally comprises a ring 25 having a substantially circular cross-section, and an annular boss 26 having a rectangular cross-section and projecting radially inward from the ring 25. The perimeter member 24 is dimensioned such that the grid member 20 fits flush onto the boss 26, seated thereon and abutting the ring 25. The perimeter member 24 may be attached, via the use of a commercially-available adhesive, to the bottom surface 23 of the grid member 20 along a surface of the boss 26. The ring 25 may be hollow to define a chamber 27 that forms an entrapped air pocket, or which may be filled with an internal buoyant material (e.g. closed-cell foam) with a plurality of small entrapped air pockets, to assist in providing the apparatus 10 with the desired overall density. The material of construction for the perimeter member 24 should provide a sufficiently low coefficient of friction against the walls 82 of the paint can/bucket/storage container 80 so as not to impede its displacement, as well as appropriate resiliency, and durability. Most plastics are well-suited for this purpose. Thus, in the preferred embodiment the perimeter member 24 is integrally molded from a commercially-available plastic material such as Acrylic™ or PVC using a conventional injection molding process. The boss 26 protrudes from the ring 25 at a point that submerges the grid member 20 just below the surface of the paint when ring 25 is floating thereon. It is noteworthy that the injection molding process may be used to form the grid member 20 and the perimeter member 24 as a single, integral unit. Ring 25 does not need to have a particular buoyancy to submerge the grid member 20 just below the surface. It is sufficient that ring 25 be buoyant relative to paint. This is because conventional paint is highly viscous, and when carried in a bucket the pressure from the paint forcing against the wall of the interior of the bucket makes the paint stable and gives a surface tension sufficient such that most any lighter-weight material will float on top the paint (paper, plastic, even cloth) without sinking (at least until the material becomes saturated and will sink over time, but this takes days or even weeks). Thus, the present paint flow control apparatus 10 will float on top of the paint despite the holes in it, and the user may apply pressure to the top of the apparatus 10 as necessary to force a desired amount of paint up through the holes (this action results in the grid member 20 being submerged just below the surface of the paint even though it does not sink of its own accord).

The filter screen 28 of the apparatus is removably attached to the bottom surface 23 of the grid member 20 by a plurality of removable rivet-type fasteners 30. The mesh of the filter screen 28 strains the paint by preventing particulate matter (especially dried paint) from passing through the holes 21 formed in the grid member 20 where they may be picked up by a conventional paint roller applicator. The mesh size of the filter screen 28 may be varied by a user depending upon the size of the particulate matter that is to be retained in the storage container (i.e. prevented from transferring onto the roller), and a 100 mesh filter will suffice. The fasteners 30 are preferably removable rivet-type fasteners that temporarily affix the screen member 28 to the grid member 20 by extending through the filter screen 28 and anchoring it into one of the holes 21 of grid member 20. The fasteners 30 should have stems capable of being compression-fitted or detent-fitted into the holes 21 to allow the filter screen 28 to be removed from the grid member 20 so that when it becomes clogged due to the filtering out of inappropriate particulate matter, it may be removed and cleaned or replaced by a new one. The filter screen 28 is preferably fabricated of a commercially-available metallic or Nylon™ screening. However, screening fabricated of any other material possessing an appropriate degree of particle retention and durability may be used. The shape of the filter screen 28 conforms to that of the grid member 20 and, as an alternative to the circular form, may when required take on another geometric shape such as a square or a rectangle.

At least two handles 32 are fixedly attached to the perimeter member 24 and protrude upwardly to provide the ability to conveniently extract the apparatus 10 from a paint can/bucket/storage container 80. In the preferred embodiment, each handle 32 is formed as a flat upward rectangular protrusion defined by a notch 34 formed inwardly of a side edge. The handles 32 are preferably fabricated of a commercially-available plastic material such as Acrylic™ or PVC, and may be attached to the perimeter member 24 via a commercially-available adhesive, plastic welding, or integral molding (the same injection molding process may be used to form the grid member 20, the perimeter member 24, and the handles 32 as a single, integral unit), and in all such cases are positioned substantially perpendicular to the grid member 20. The presence of notches 34 on handles 32 allows the apparatus 10 to be temporarily hooked over the top rim of a paint storage container 80. To improve their grip on the rim, the notches 34 on handles 32 may be covered by rubber strips or a coating.

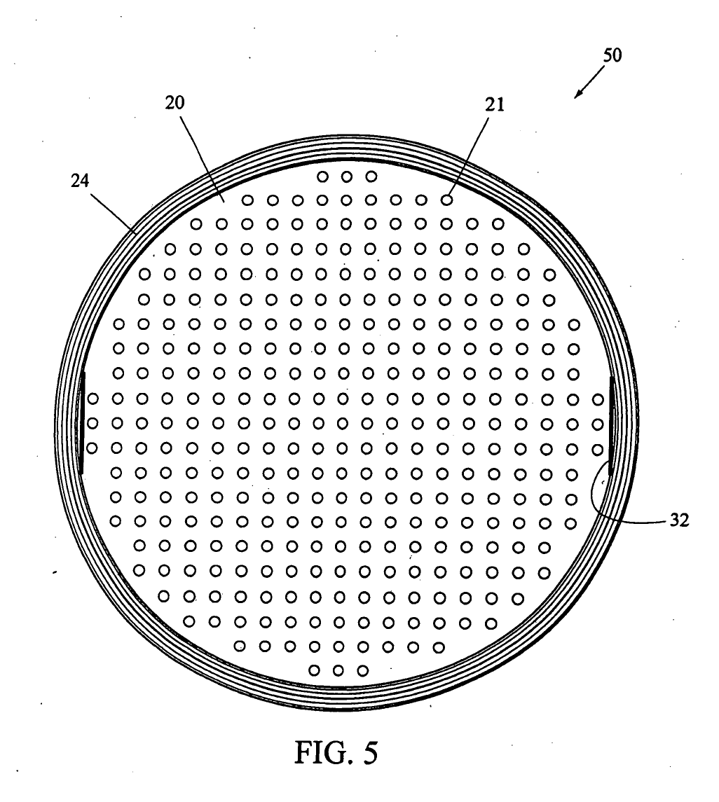

In the embodiment illustrated above in FIGS. 1-4 the filter screen 28 is removably attached to the other components of the apparatus 10. However, as shown in the alternate embodiment of FIG. 5, the filter screen 28 may be omitted leaving grid member 20, perimeter member 24, and handles 32. Without filter screen 28, the ability of the apparatus 50 in straining, or filtering, the paint as it transfers onto a roller is limited to particulate matter that is larger than the diameter of the through holes 21 in the grid member 20.

In use of the above-described apparatus 10, 50, the grid member 20 is designed to be submerged just below the surface 85 (see FIG. 3) of the paint supply held within a storage container 80, thereby allowing a conventional paint roller or brush to be rolled/brushed across the grid member's top surface 22 to pick up an appropriate amount of paint. Pressure is the key to properly submerging the grid member 20, and the user controls the amount of paint they want access to (atop the grid member 20) by applying more or less pressure to the flow control apparatus 10. The more pressure that is applied, the faster the paint rushes up through the grid member 20 and filter screen 28 to the top to fill the needs of the user and whatever paint applicator-roller system is being used. Less pressure results in less paint.

By being generally positioned just below the surface 85 of the paint, the apparatus 10, 50 of the present invention eliminates the atmospheric exposure (i.e. the drying process) that results in wasted paint and/or the formation of inappropriate particulate matter. Paint is forced through the holes 21 in the grid member 20 and the mesh of the screen member 28 as downward force is applied by a roller being rolled back and forth across the top surface 22. The screen member 28 strains the paint prior to its pick up by the roller and subsequent application to a wall, ceiling, etc.

To extract the apparatus 10, 50 from the storage container 80, such as for the purpose of refilling the container 80, a user may grasp the handles 32 which are angled to extend above the surface 85 of the paint at all times. While the refilling process is completed, the apparatus 10, 50 may be temporarily supported on the top rim of the container 80 by engaging the notches 34 formed in the handles 32 with that rim. Once the container 80 is appropriately refilled, the apparatus 10, 50 is returned to its operating position just below the surface 85 of the paint.

It should now be apparent that the above-described apparatus 10, 50 provides an improved paint flow control apparatus that (1) eliminates the atmospheric exposure resulting in wasted paint and/or the formation of inappropriate particulate matter, (2) serves as a paint strainer to prevent any particulate matter from transferring onto the roller and subsequently being applied to a surface, (3) possesses a simple, yet scalable, design fabricated of buoyant, resilient, durable materials, and (4) may be economically manufactured and sold to provide for widespread use.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A paint flow control apparatus for insertion into a conventional paint container to regulate the application of paint to a paint roller or brush, comprising:
a submersible grid member defined by a top surface, a bottom surface, and a plurality of through holes;
a buoyant perimeter member attached peripherally about said grid member to float on paint in said paint container and thereby suspend said grid member in a submersible position at the surface of the paint in said paint container; and
at least one handle fixedly attached to said perimeter member and protruding upwardly perpendicular to said grid member;
whereby placement of said apparatus in a paint storage container allows a user to regulate the flow of paint onto a roller or brush applicator by accumulating paint across said top surface of said grid member.

2. The flow control apparatus according to claim 1 wherein said buoyant perimeter member further comprises a hollow ring.

3. The flow control apparatus according to claim 2 wherein said buoyant perimeter member further comprises a hollow ring filled with buoyant material.

4. The flow control apparatus according to claim 3 wherein said buoyant material comprises closed-cell foam.

5. The flow control apparatus according to claim 1 wherein said buoyant perimeter member further comprises a ring having a circular cross-section and a boss protruding inwardly from said ring for seating said grid member.

6. The flow control apparatus according to claim 5 wherein said grid member is seated atop the boss.

7. The flow control apparatus according to claim 1 wherein said at least one handle comprises two handles each including a substantially rectangular member protruding upward from said perimeter member.

8. The flow control apparatus according to claim 7 wherein each of said two handles further comprises a substantially rectangular member protruding upward from said perimeter member and having a notch defined in a side edge thereof to allow said flow control apparatus to be hooked onto a rim of said paint container.

9. A paint flow control apparatus for insertion into a conventional paint container to regulate the application of paint to a paint roller or brush, comprising:
a submersible grid member defined by a top surface, a bottom surface, and a plurality of through holes;
a filter screen member conforming to said grid member and attached to one of said top or bottom surfaces;
a buoyant perimeter member attached peripherally about said grid member to float on paint in said paint container and thereby suspend said grid member in a submerged position just beneath a surface of the paint in said paint container; and
at least two handles fixedly attached to said perimeter member and protruding upwardly perpendicular to said grid member;
whereby placement of said apparatus in a paint storage container allows a user to regulate the flow of paint onto a roller or brush applicator by accumulating paint across said top surface of said grid member.

10. The flow control apparatus according to claim 9 wherein said filter screen is removably attached to said grid member.

11. The flow control apparatus according to claim 10 wherein said filter screen is removably attached to said grid member by fasteners fitted through said filter screen and into the holes of said grid member.

12. The flow control apparatus according to claim 11 wherein said fasteners comprise rivets conforming to the holes of said grid member.

13. The flow control apparatus according to claim 9 wherein said buoyant perimeter member further comprises a hollow ring.

14. The flow control apparatus according to claim 13 wherein said buoyant perimeter member further comprises a hollow ring filled with buoyant material.

15. The flow control apparatus according to claim 14 wherein said buoyant material comprises closed-cell foam.

16. The flow control apparatus according to claim 9 wherein said buoyant perimeter member further comprises a ring having a circular cross-section and a boss protruding inwardly from said ring for seating said grid member.

17. The flow control apparatus according to claim 16 wherein said grid member is seated atop the boss.

18. The flow control apparatus according to claim 9 wherein each of said at least two handles further comprises a substantially rectangular member protruding upward from said perimeter member.

19. The flow control apparatus according to claim 18 wherein each of said at least two handles further comprises a substantially rectangular member protruding upward from said perimeter member and having a notch defined in a side edge thereof to allow said flow control apparatus to be hooked onto a rim of said paint container.
